(19) United States
(12) Patent Application Publication
(10) Pub. No.: US 2026/0233231 A1
(43) Pub. Date: Aug. 13, 2026

(54) MILLING APPARATUS

(71) Applicant: GTF, LLC, Ada, MI (US)

(72) Inventors: Jay Fournier, Grand Rapids, MI (US); Joshua Manninen, Zeeland, MI (US); Michael Nicolas, Holland, MI (US)

(21) Appl. No.: 19/118,639

(22) PCT Filed: Nov. 1, 2023
(86) PCT No.: PCT/US2023/036554

§ 371 Date: Apr. 4, 2025

Related U.S. Application Data
(60) Provisional application No. 63/421,479, filed on Nov. 1, 2022.

(51) Int. Cl. B02C 13/10

(52) U.S. Cl. CPC B02C 13/10

(57) ABSTRACT

A milling apparatus which uses air pressure zones to pulverize material into smaller components. The pressure zones are created by a lobe-lined chamber defined within a housing containing a rotating plate affixed with vanes. When material is fed into the chamber through an inlet, the rotation of the vanes pushes material from high-pressure zones to low pressure zones causing the product to pulverize into smaller components before exiting the chamber through an outlet. Changing the shape of the lobes, adjusting the shape and types of the vane tips, and inserting ramps into the chamber customizes the efficiency of the milling apparatus on different products.

### PRIORITY

This application claims priority to U.S. provisional application Ser. No. 63/421,479, filed Nov. 1, 2022, the entire contents of which is incorporated herein by reference.

### TECHNICAL FIELD

This invention pertains to an apparatus and method for milling or grinding matter into particles and powders.

### BACKGROUND OF THE INVENTION AND TECHNICAL PROBLEMS POSED BY THE PRIOR ART

In the field of material processing, it is often necessary to reduce raw materials (hereafter referred to as a “material”), organic or inorganic, to a powder or granular form for use and consumption. The most common form of this grinding process is contact grinding, where the substance being milled is subjected to high degrees of friction and/or impact force which smashes the material apart into smaller particle components. This contact, however, is often accompanied with numerous negative side-effects and downsides like product inefficiencies and microbial contamination.

The present invention addresses these disadvantages of contact milling by using air pressure to pulverize the material being processed. This pneumatic system kills bacteria and reduces production-related milling efficiencies.

The inventors of the present invention have discovered how to provide an improved milling apparatus and method that includes novel, advantageous features not heretofore taught or contemplated by the prior art, and which can accommodate designs having one or more of the above-discussed benefits or features.

### SUMMARY OF THE INVENTION

According to broad aspects of one form of the present invention, claimed invention is an apparatus for pulverizing wet or dry material into relatively smaller components, wherein the apparatus comprises. The apparatus defines an enclosed chamber, wherein the chamber has at least one inlet through which material may enter the chamber and at least one outlet through which material may exit the chamber. The chamber's interior is circumferentially arrayed with at least one lobe that extends inwards from the chamber walls towards the center of the chamber. The apparatus includes a rotatable shaft crossing from one side of the chamber to the other side and at least one rotor assembly coupled to the rotor shaft, wherein each rotor assembly includes a plate or series of plates. The plates have a series of vanes which extend across the plates and terminate in a vane tip. The apparatus includes a motor operatively connected to the rotatable shaft and adapted to spin the rotor assembly.

In one preferred form of the present invention, the chamber's interior is circumferentially arrayed with at least one wave-shaped lobe that extends inwards from the chamber walls towards the center of the chamber, wherein the lobe has a first side that extends with a shallow slope from the base of the lobe to the top side of the lobe, and a second opposite side that extends with a sharp slope down to the base of the lobe, and wherein the base of the lobe is at the same distance as the chamber walls from the center of the chamber.

In another preferred form of the present invention, the rotor assembly plates have at least one vane which extends across the plate, wherein each vane has an adjustable or removable tip at the edge of the plate.

According to another preferred form of the present invention, the apparatus interior chamber has a ramp leading to the inlet, wherein the ramp has a first shallow end pointing opposite to the rotor assembly's direction of rotation and a second relatively higher end pointing in the direction of the rotor assembly's direction of rotation.

It should be appreciated that the invention may include any or all of the above-described features, include only one of the above-described features, more than one of the above-described features, and any combination of the above-described features. Furthermore, other objects, features and advantages of the invention will become apparent from a review of the entire specification including the appended claims and drawings.

### BRIEF DESCRIPTION OF THE DRAWINGS

FIG. 1 is an isometric view, taken from above, of a first embodiment of a milling apparatus according to the present invention with associated equipment in a material processing line;

FIG. 2 is an isometric view, taken from the front and above, of only the milling apparatus of FIG. 1, and FIG. 2 shows housing inlet and motor of the milling apparatus;

FIG. 3 is an isometric view, taken from the rear and above, of the milling apparatus of FIG. 2, and FIG. 3 shows housing outlet;

FIG. 4 is a cross-sectional view, taken along a vertical plane extending along the horizontal axis of the rotational shaft of the milling apparatus of FIG. 2;

FIG. 5 is an exploded view of the milling apparatus of FIG. 2;

FIG. 6 is a cross-sectional view, taken along a vertical plane extending perpendicular to the horizontal axis of the rotational shaft of the milling apparatus of FIG. 2;

FIG. 7 is an isometric cross-sectional view, taken along a vertical plane extending perpendicular to the horizontal axis of the rotational shaft of the milling apparatus of FIG. 2;

FIG. 8 is an isometric view, taken from the front and above, of a second embodiment of a milling apparatus according to the present invention, and FIG. 8 shows the housing inlet and motor of the milling apparatus;

FIG. 9 is a cross-sectional view, taken along a vertical plane extending perpendicular to the horizontal axis of the rotational shaft of a portion of the housing of the milling apparatus of FIG. 8, and FIG. 9 shows the modified, wave-like lobe configuration within the interior chamber of the housing;

FIG. 10 is an isometric cross-sectional view, taken along a vertical plane extending perpendicular to the horizontal axis of the rotational shaft of a portion of the housing of the milling apparatus of FIG. 8

FIG. 11 is an exploded, isometric view, taken from the front and above, of the rotor assembly of the milling apparatus of FIG. 8;

FIG. 12 is a left side elevational view of the rotor assembly of FIG. 11;

FIG. 13 is an exploded, isometric view, taken from the front and below, of a portion of a housing of the milling apparatus of FIG. 8, and FIG. 13 shows an optional ramp located proximate to the inlet and a removable vane tip;

FIG. 14 is a front elevation view of a portion of the housing and rotor assembly of the milling apparatus of FIG. 8;

FIG. 15 is an enlarged, fragmentary view of the circled portion of the housing and rotor assembly in FIG. 14;

FIG. 16 is a cross-sectional view, taken along a vertical plane extending perpendicular to the horizontal axis of the rotational shaft of a portion of the housing of and rotor assembly of the milling apparatus of FIG. 8, and FIG. 16 shows the location of the ramp to the inlet of the housing;

FIG. 17 is an enlarged, fragmentary view of the circled portion of the housing and rotor assembly in FIG. 16;

FIG. 18 is a cross-sectional view of the housing and rotor assembly, taken along view plane 18-18 in FIG. 16;

FIG. 19 is a front elevation view of another embodiment of a rotor assembly plate for a milling apparatus of the present invention, and FIG. 19 exhibits different connecting means for the removable tip portions of the vanes;

FIG. 20 is an exploded, isometric view, taken from the front and below, of the rotor assembly plate of FIG. 19;

FIG. 21 is an isometric view, taken from the front and below, of the rotor assembly plate of FIG. 19;

FIG. 22 is an enlarged, fragmentary view of the rotor assembly plate of FIG. 19;

FIG. 23 is an enlarged, fragmentary view of the rotor assembly plate of FIG. 19, and FIG. 23 shows the tips removed radially from the vanes;

FIG. 24 is an enlarged, fragmentary, exploded view of the rotor assembly plate of FIG. 19;

FIG. 25 a front elevation view of a portion of the housing and rotor assembly of the milling apparatus of FIG. 8;

FIG. 26 is a greatly enlarged, fragmentary view of the circled portion of the housing and rotor assembly of FIG. 25, and FIG. 26 shows the spacing of the vane tips from the lobes extending circumferentially around the chamber interior

FIG. 27 is a front elevation view of a portion of a housing and a rotor assembly of another embodiment of a milling apparatus according to the present invention, and FIG. 27 shows the wave-like lobe configuration within the housing having a different ornamental design; and

FIG. 28 is an enlarged, fragmentary view of the circled portion of the housing and rotor assembly in FIG. 27.

### DESCRIPTION OF THE PREFERRED EMBODIMENTS

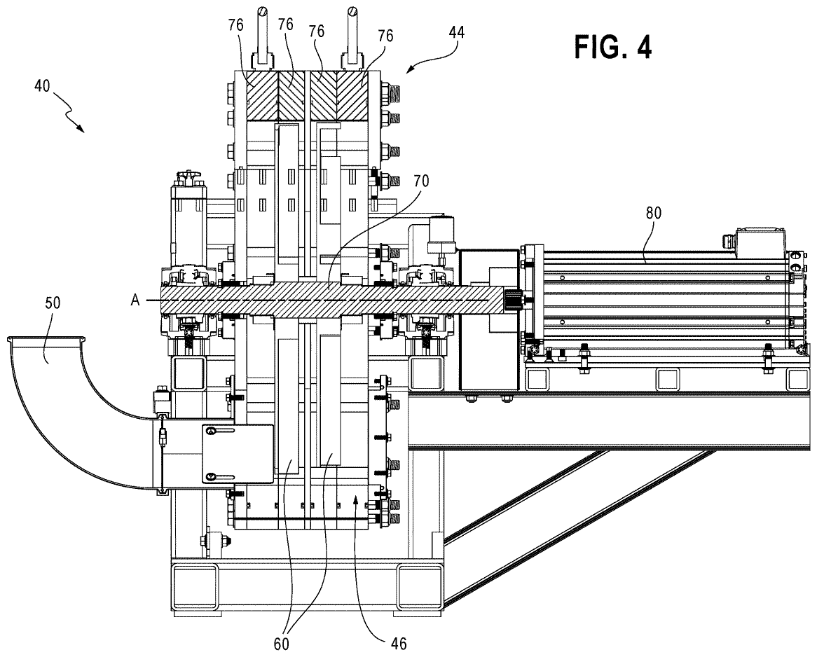

For ease of description, many figures illustrating the invention show embodiments of a milling apparatus 40 in the typical orientation that the apparatus 40 would have when located (i.e., installed, attached, etc.) in a material (e.g., food or grain) processing line, and terms such as “inward”, “outward”, “upper”, “lower”, “axial”, “radial”, “lateral”, etc., are used with reference to this orientation. The term “radially inward” is to be understood as in the radial direction toward the central rotational axis “A” (FIG. 4). The term “radially outward” is to be understood as in the radial direction away from the central axis “A”.

The apparatus described herein is a milling device that uses air pressure to pulverize material into smaller pieces by moving the material between high-and low-pressure areas inside a chamber. Collectively, this apparatus is referred to as a “pressure mill.” The mill can pulverize various inorganic substances, including but not limited to rubber, metal, glass, silica, and minerals. Furthermore, the mill is capable of pulverizing a variety of organic substances, including but not limited to wood, grain, flour, fruit and vegetable parts, and other edible substances.

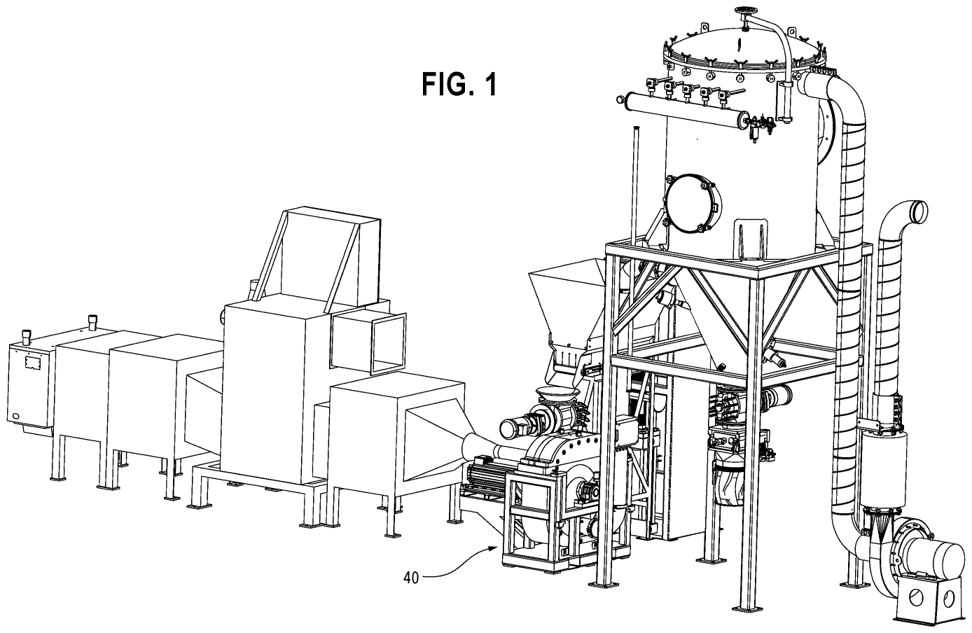

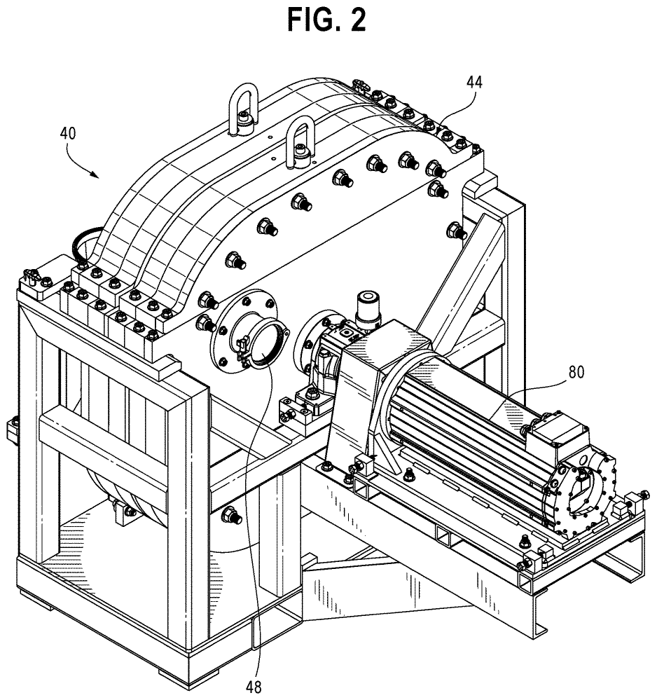

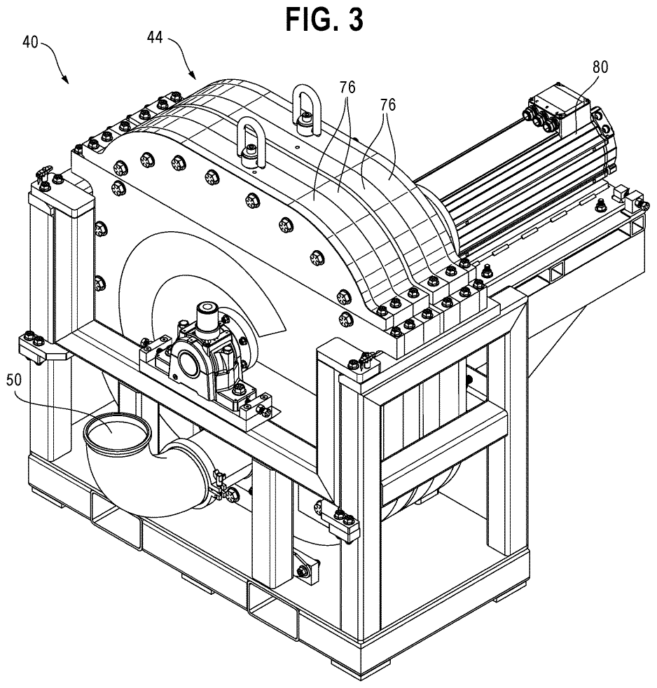

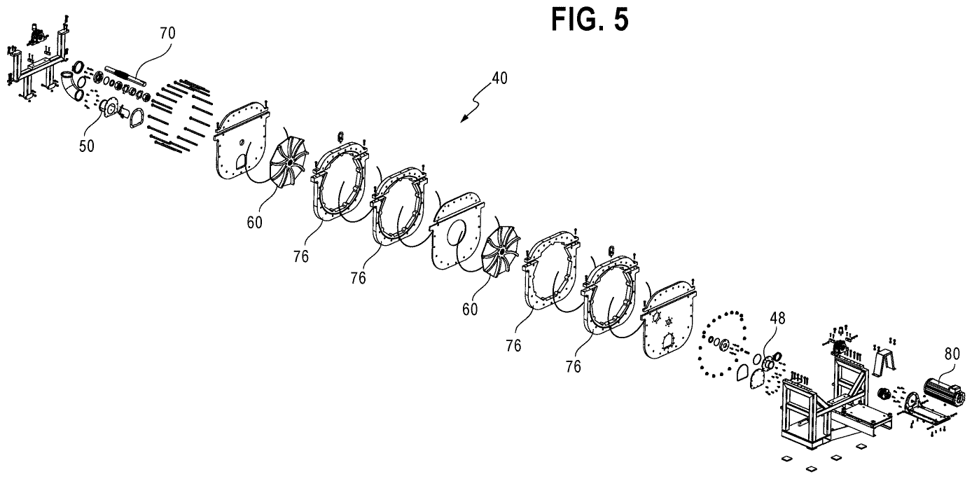

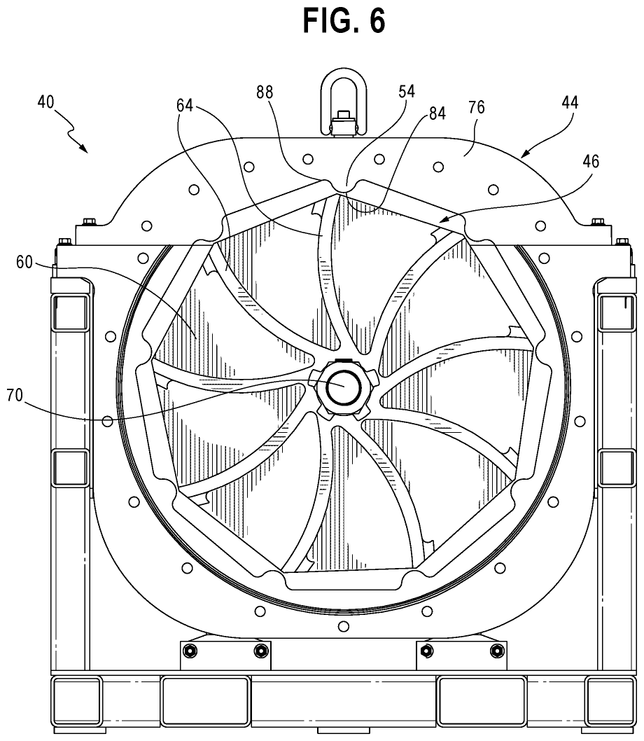

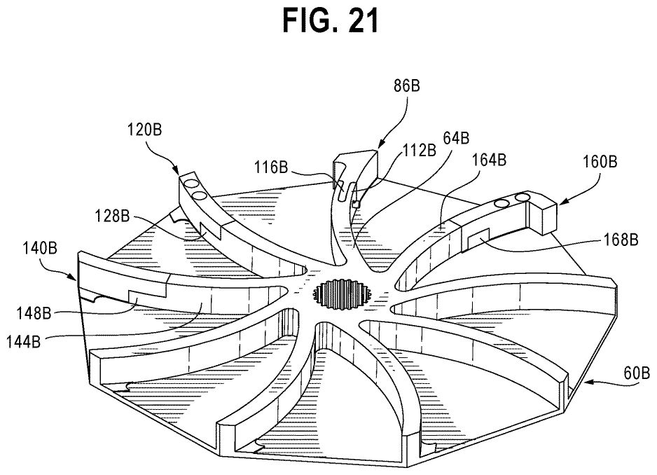

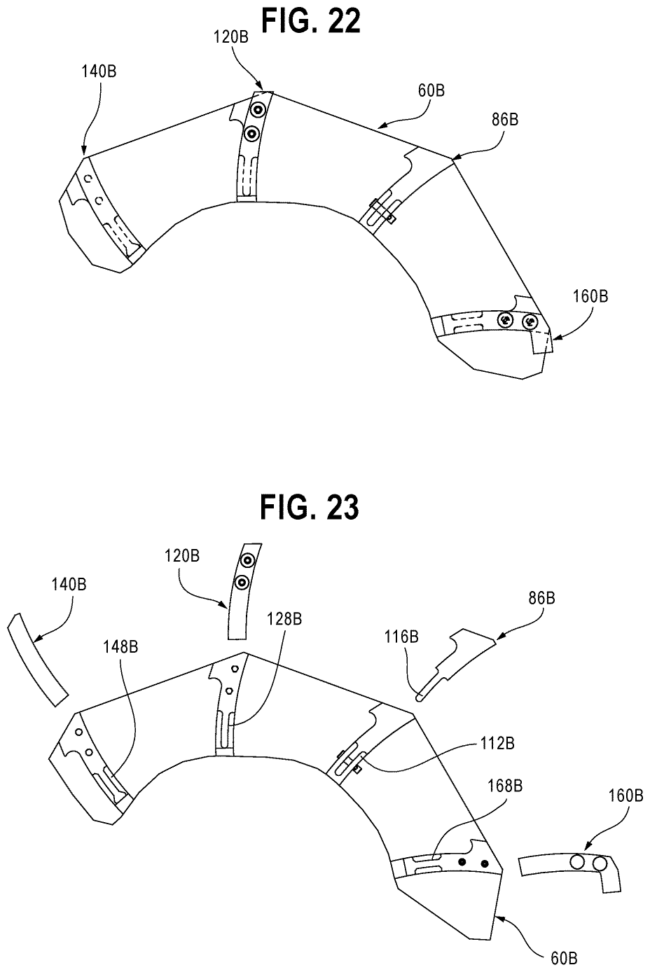

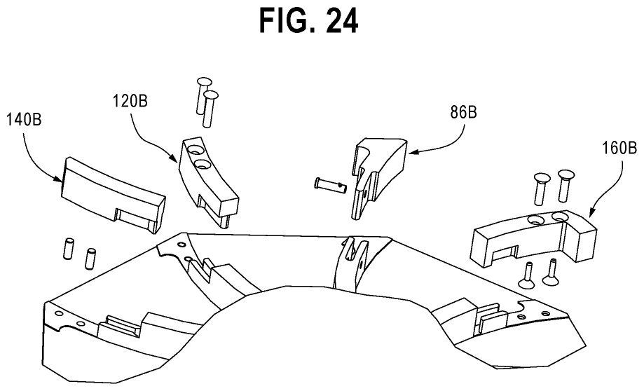

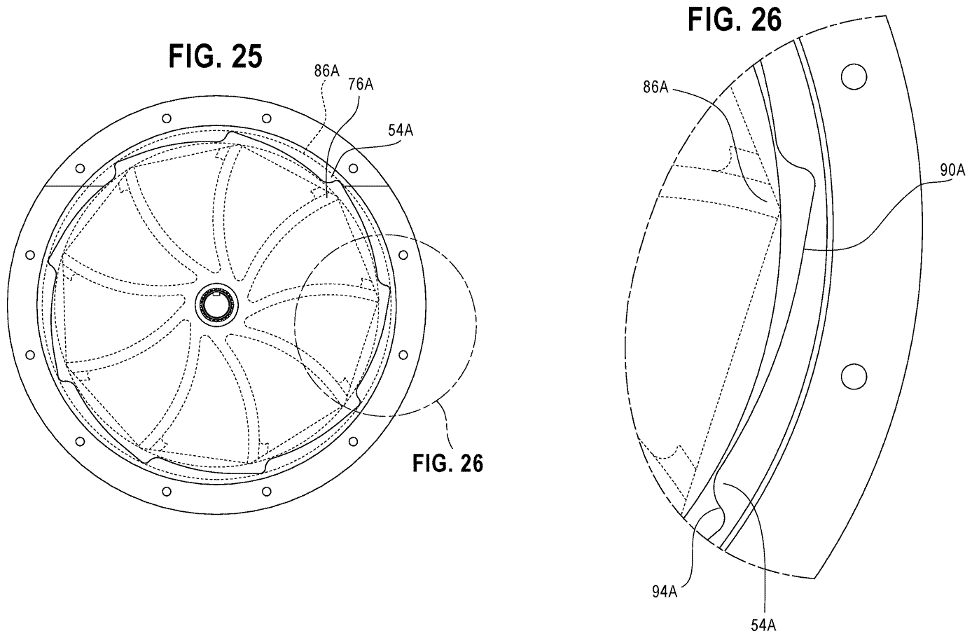

Referring to FIGS. 1-7, a first illustrated embodiment of the milling apparatus or pressure mill 40 is shown. The mill 40 includes six basic or central components: a housing 44 defining an internal cavity or enclosed chamber 46, an inlet 48 at the front of the housing 44 to the mill 40, an outlet 50 at the rear of the housing 44 of the mill 44, at least one lobe 54 on the interior circumference of the chamber 46 (though more than one lobe 54 is preferable), a rotor plate 60 with vanes or vane blades 64 affixed to a rotating shaft 70 that runs through the center of the chamber 46 (collectively known as a rotor assembly 74), and a motor 80 to turn the rotor assembly 74 relative to the lobes 54. The housing 44 preferably is comprised of multiple lobe plates 76 that are stacked or assembled to the desired axial depth of the mill 40. The pressure mill 40 functions when the rotor plate 60 is spun at about 2,500 to about 10,000 revolutions per minute (“RPM”), which creates a relatively high-pressure zone in front of the rotor plate 60 near the inlet 48, and a relatively low-pressure zone behind the rotor plate 60 near the outlet 50. The rotor vanes 64 of the rotor plate 60 should extend from the center of the plate radially towards the edge of the plate 60. The vanes may extend in a straight line (not illustrated) or in a spiraling design (as shown in FIG. 6), the choice of which affects efficiency depending on the material being pulverized. The vanes 64 should terminate at the radial edge or end of the plate, though in other embodiments of this invention the vanes terminate near the end of the plate or hang off the end of the edge of the plate 60 (as shown FIGS. 19-24).

The difference between these pressure zones creates a suction effect that pulls material from the front to the rear of the mill 40. As material follows this suction effect from the front to the rear of the mill 40, the rotor plate vanes 64 redirect the material's flow out to the walls of the chamber 46. This redirection forces the material being processed to flow and circle around the inner surface of the walls of the chamber 46 while simultaneously being drawn towards the rear of the mill 40 by the pressure zone suction.

As the vanes 64 move the material around the perimeter of the chamber 46, the material regularly encounters lobes 54 extending from or embedded in the inner surface of the chamber 46. These lobes 54 protrude internally from the walls of the housing 44 such that the top point 84 of each lobe 54 is at a height adjacent (but not touching) to the circumference of the tips 86 of the rotating vanes 64 or the rotor plate 60, whichever is further from the center of the chamber 46. Conversely, the base 88 of the lobes 54 (which is the surface of the chamber wall itself) should be at a relatively large distance from the edge of the vane tips 86.

The lobes 54 should be sufficiently high that the top point 84 of each lobe 54 is greater or equal to one-thousandth of an inch from the tip 86 of the rotating vanes 64 or circumference of the rotating plate 60, but not so low that the top point 84 of the lobe 54 is greater than one inch from the circumference of the rotating vanes 64 or rotating plate 60. Should the lobes 54 fall outside these height limitations, the mill 40 will not pulverize material efficiently. FIG. 26 illustrates these preferred ranges for one embodiment of the invention.

Similarly, the base 88 of the lobes 54 (which are at the overall diameter of the walls of the chamber 46) should be at such a distance from the center of the chamber 46 that the base 88 is greater than, or equal to, one-quarter of an inch from the tip 86 of the circumference defined by the rotating vanes 64 or the circumference of the rotating plate 60, but not so low that they are greater than five inches from the tip 86 of the circumference defined by the rotating vanes 64 or the circumference of the rotating plate 60. FIG. 26 illustrates these preferred ranges for one embodiment of the invention.

The lobes 54 of the mill 40 should have a height between one-quarter of an inch and five inches from the base 88 of the lobe 54 (the interior surface of the wall of the housing 44 that defines the chamber 46) to the topmost point 84 of the lobe 54. This lobe height should be selected such that the top of each lobe 54 is within a distance of greater or equal to one-thousandth of an inch to one inch from the tips 86 of the circumference of the rotating vanes 64 or circumference defined by the rotating plate 60.

The lobes 54 serve a twofold purpose. First, the narrow distance between the lobe 54 and the vane tips 86 creates a shockwave whenever a vane 64 passes the lobe 54. As material circles the walls of the chamber 46 and enters this space between the lobes 54 and rotor assembly 74, the resulting shockwaves pulverize the material into relatively smaller pieces.

Second, the angled shape of the lobe 54 redirects the material being pulverized back towards the center of the mill 44. This redirection forces the material back into the vanes 64, which redistributes the material back onto the surface of the chamber walls for further shockwave pulverization at the lobes 54.

Eventually, after being pulverized numerous times, the material reaches a fine enough pulverized condition that the suction effect of the mill 40 is sufficient to drag the material beyond the rotor assembly 74 towards the back of the mill 40. Upon reaching the back of the chamber 46, the suction effect of the mill 40 pushes the pulverized material out of the rear outlet 50 of the housing 44. This ejected material can then be optionally introduced to subsequent pressure mill chambers for further pulverization.

Importantly, while the illustrated embodiments of the present invention illustrate a single chamber, it will be understood that there is no limit to the number of pressure mill chambers that can be used successively, as each chamber adds to the suction effect of the previous chamber and increases the granulate size consistency of the final output of the mill 40.

The operating efficiency of the mill 40 can be tuned to match the material being processed by changing several configurations of the components of the mill 40. The first of these configuration changes is the rotational speed of the rotor plates 60. When the rotor plate RPM is increased, material is processed into relatively smaller and finer pieces. Conversely, when the rotor plate RPM is decreased, the shockwaves between the rotor assembly 74 and the chamber lobes 54 are insufficient to create strong enough shockwaves to pulverize the material being milled. Furthermore, if the rotation is too slow, and the material being processed contains any moisture (grain has moisture, for example), then the material is transformed into a paste instead of a particulate. This paste wastes material and clogs the mill, resulting in an increased need to clean and maintain the mill 40, causing mill downtime and reduced milling efficiency.

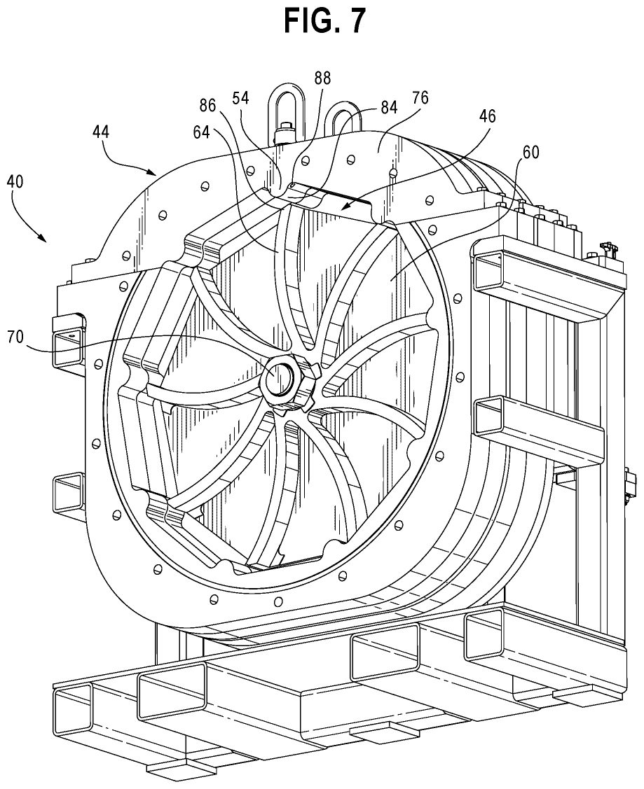

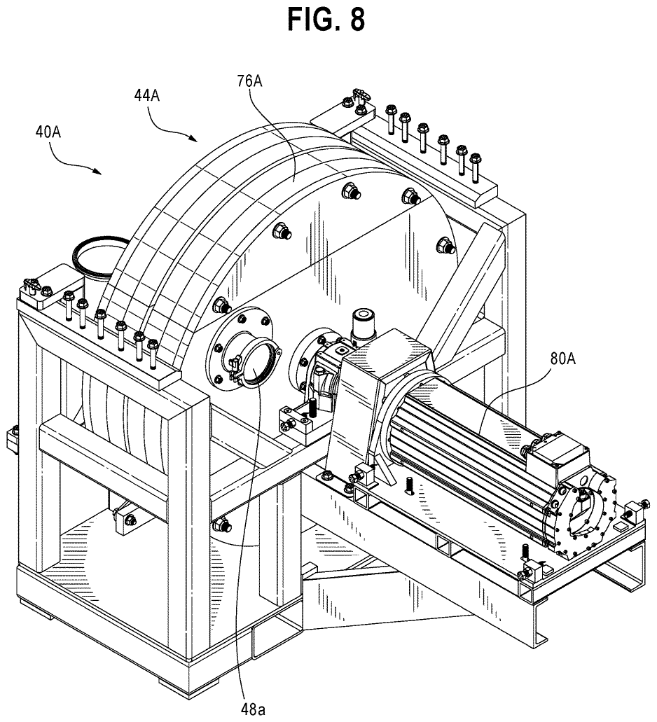

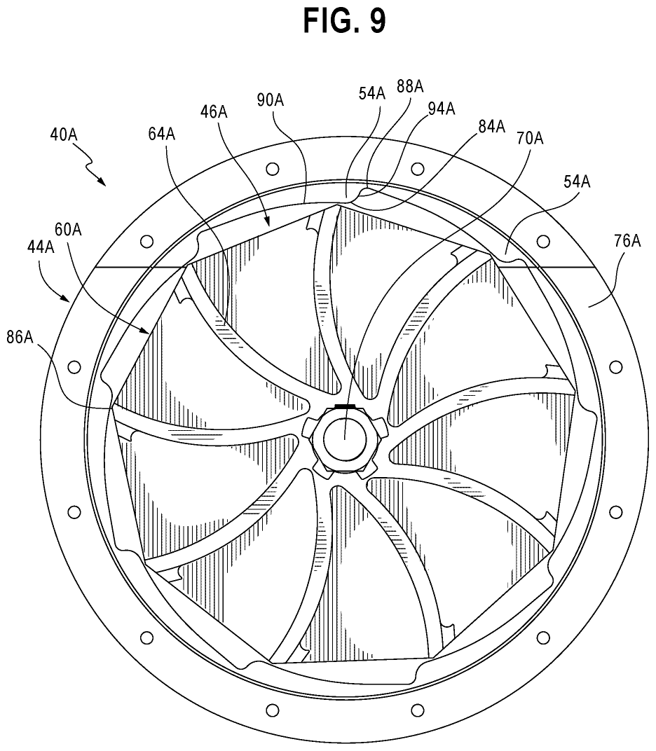

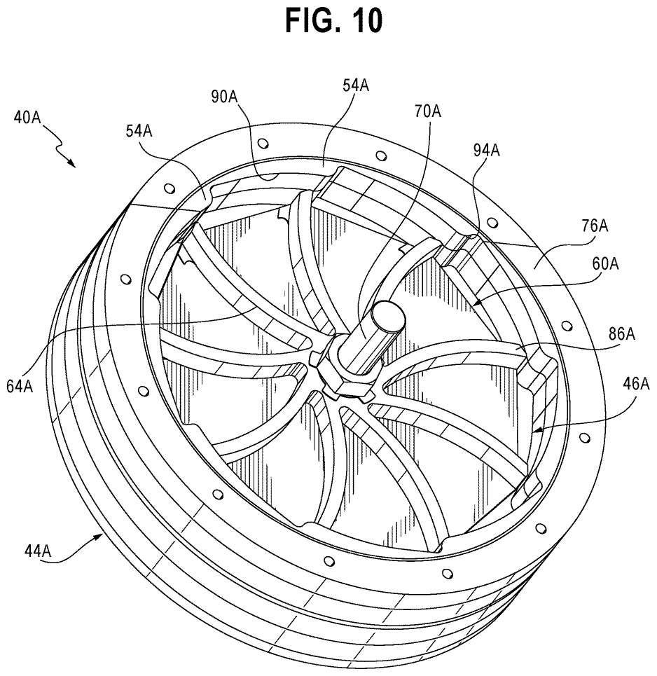

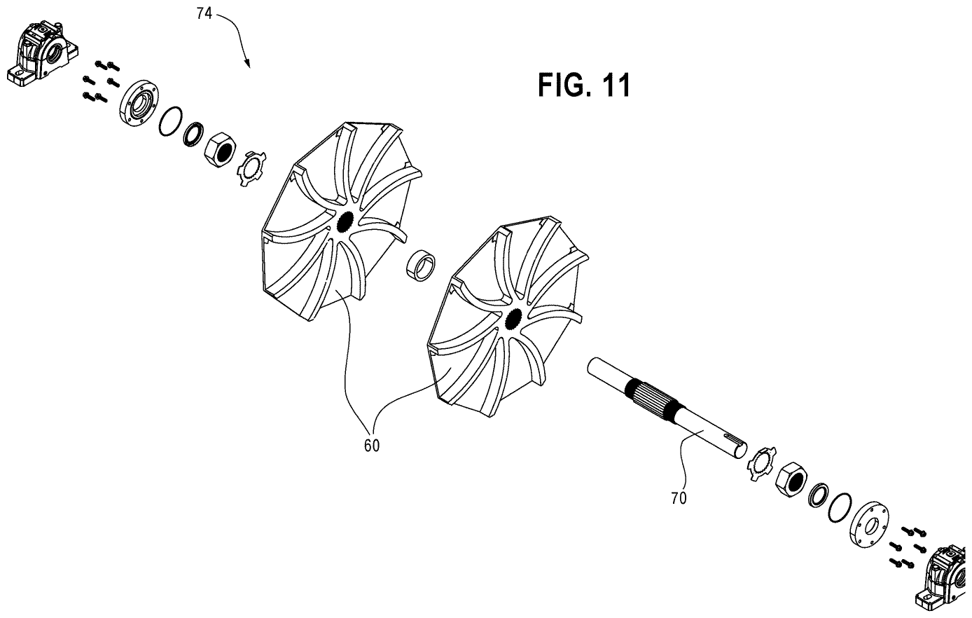

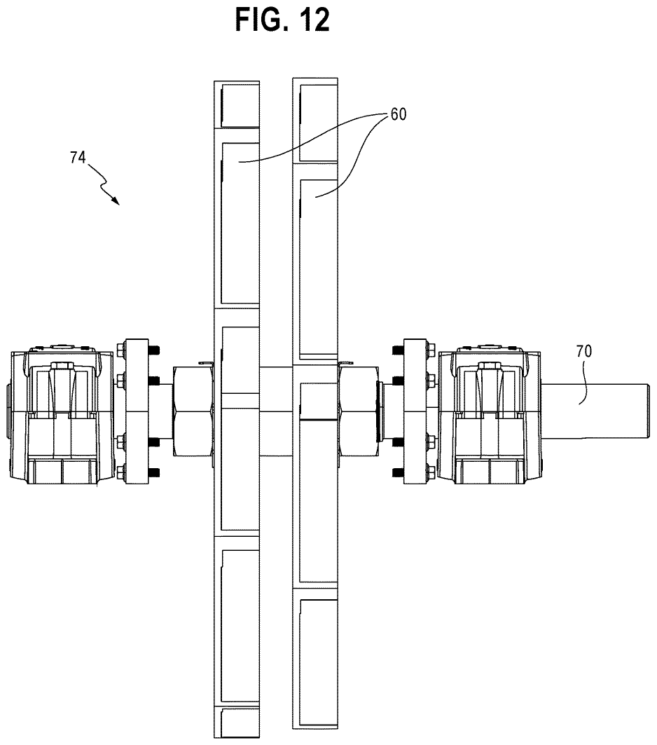

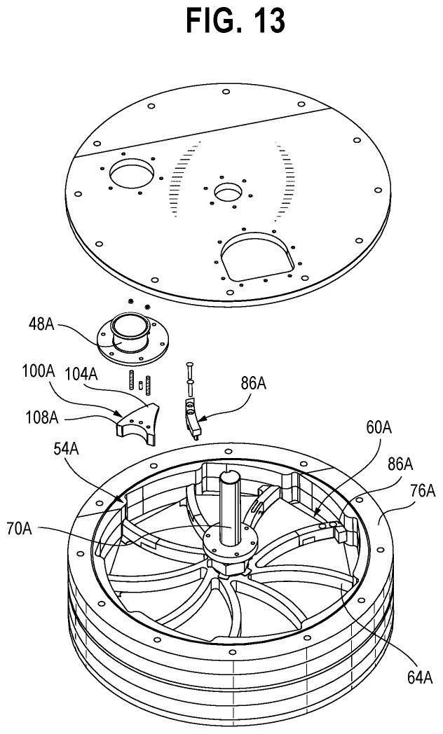

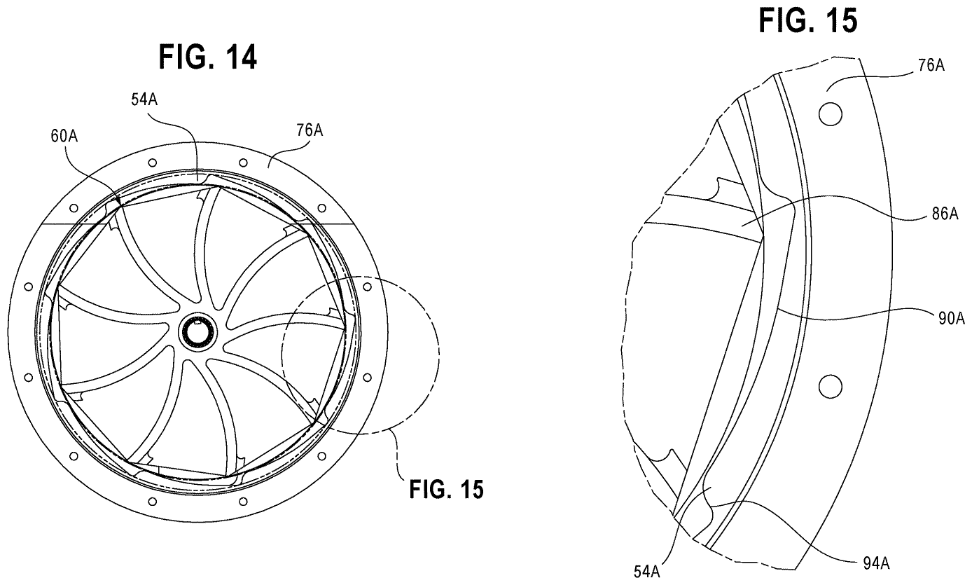

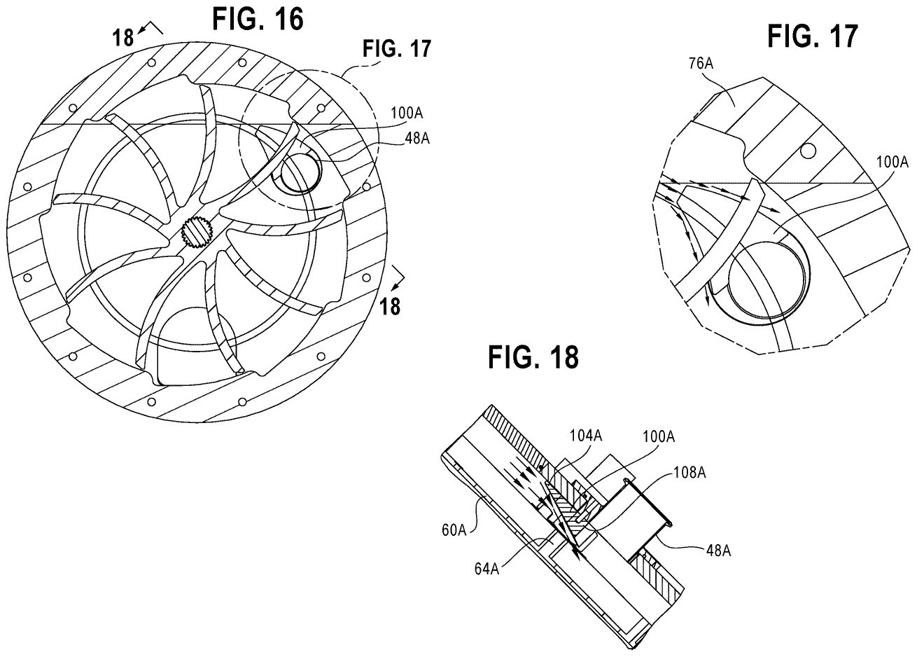

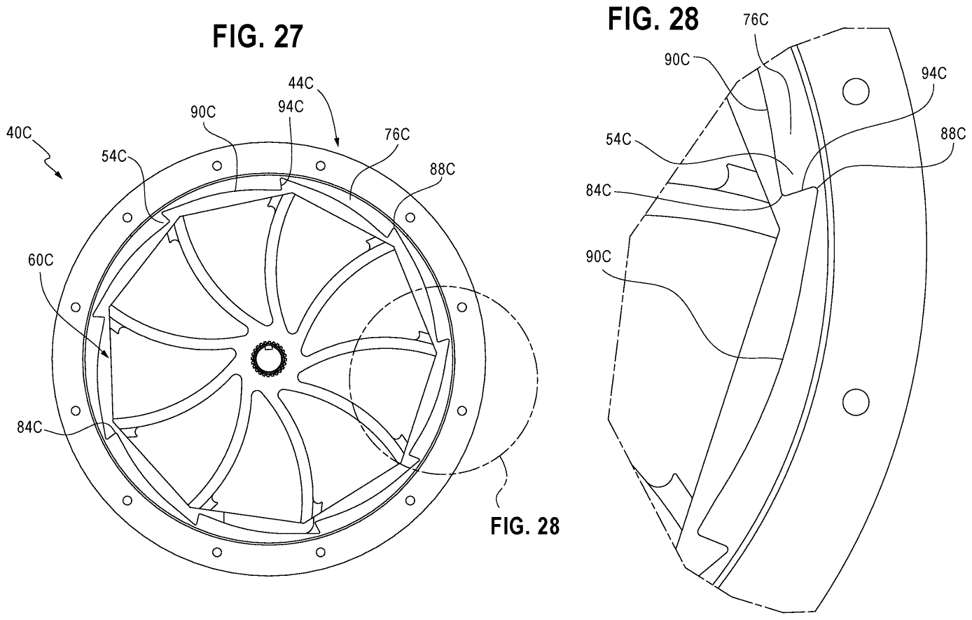

The second operational configuration that can be varied to tune the processing efficiency of the mill 40 is the shape and height of the lobes 54 within the chamber 46. In the basic mill configuration (illustrated in FIGS. 6 and 7), the chamber lobes 54 take the form of small and abrupt symmetrical “mounds” that rise steeply from the base 88 of the lobe 54 (at the chamber wall) to the peak 84 of the lobe and then fall at the same steep angle back to the base 88 of the lobe 54. However, the inventors have found that by changing the shape of the chamber lobes to a wavelike shape, as shown in a preferred second embodiment of the mill 40A illustrated in FIGS. 8-10 and 13-18, the grinding efficiency of the mill 40A can be increased. Like elements between the first illustrated embodiment of the mill 40 and the second illustrated embodiment of the mill 40A are designated with the same numeral (the first embodiment numbered features having no suffix and the second embodiment having numbered features with an “A” suffix). This wavelike shape of the lobes 54A should consist of repetitive swells surrounding the internal circumference of the chamber 46A as defined by the plates or walls 76A of the housing 44A, where each lobe 54A has a first long side 90A that slopes shallowly from the base 88A of the mound to the top point 84A of the lobe 54A. At the top point 84A, the lobe 54A then has a second short side 94A that sweeps back to the base 88A of the lobe 54A (at the chamber wall) in either a short and steep slope (illustrated in FIG. 9) or at a direct ninety-degree angle (as illustrated in FIGS. 27 and 28, which will be discussed in detail hereinafter).

While the wavelike lobe shape is the ideal and most efficient embodiment of the lobe shape of the mill, the general shape of the lobe can be modified to optimize the mill for different materials so long as the lobes have a long sloping side up from the base of the lobe and a relatively short side that returns to the base of the lobe. This formation of the lobes increases the shockwave strength of the pressure mill and reduces the need for mill cleaning and maintenance by reducing the wear on mill components because the increased shockwave is spread out over a larger lobe (instead of a single small point on a normal symmetrical lobe).

The mill needs at least one lobe to function but increasing the number of lobes creates a higher level of mill efficiency. The preferred embodiment of the invention has a range of lobes between seven and twelve, with a standard number of nine lobes.

With reference now to FIGS. 13 and 18, the operational efficiency of the mill can be further improved by introducing a ramp 100A surrounding the inlet 48A to the chamber 46A. This ramp 100A has a first shallow end 104A facing towards the direction the rotor plate spins and its heightened opposite end 108A in the direction the rotor assembly rotates. The ramp 100A terminates into a ring shape (as can be seen in FIGS. 13 and 16) with walls extending down to the base of the ramp 100A.

The ramp 100A is placed inside the chamber such that its ring shape encloses the inlet 48A in the chamber wall. This placement allows the mill 40A to redirect material swirling inside the chamber 46A away from the inlet 48A. This redirection prevents the inlet 48A from becoming clogged with excess material, allowing greater lengths of time between mill maintenance periods, thus increasing mill production efficiency. Furthermore, the ramp 100A increases mill efficiency by redirecting the material flow back into the vanes 64A for further pulverization.

The rotor plate 60A has at least one vane 64A affixed to, or otherwise extending from, its surface on the side facing the inlet 48A of the chamber 46A. However, numerous vanes 64A are preferable as they shift material more efficiently through the mill 40A. The most preferred embodiment of this invention has nine vanes 64A affixed to the rotor plate 60A. These vanes 64A extend radially across the surface of the mill from the center of the plate 60A and have tips 86A near the edge of the rotor plate 60A. In the basic configuration of the mill 40A, the vane tips 86A are an integral part of the rotor plate 60A and vane 64A. However, the inventors have found that if the vane tips 86A are made to be adjustable or replaceable, then the efficiency of the mill 40A is significantly increased. FIGS. 19-24 illustrate different variations of adjustable and/or removable vane tips 86A, which will be discussed in greater detail below.

Because the tips of the rotor vanes create the shockwaves that pulverize the material, the tips wear out relatively quickly compared to the rest of the mill. Making the vane tips removable or adjustable makes the mill easier to maintain and use. As vane tips wear out, the mill's user only needs to replace the tips instead of the whole rotor plate. This saves mill operators an extensive amount of operational costs.

Furthermore, the adjustable and replaceable tips allow for a great degree of custom tailoring based on the product being pulverized. Different materials are pulverized more efficiently with different vane tip shapes, so removable vane tips allow for rapid mill customization. Without replaceable vane tips, an expensive team of service workers would be needed to remove and replace the extremely heavy and massive rotor plates whenever the mill needs customization. With replaceable vane tips, however, only a single service worker with a few hand tools is needed to remove and reattach the vane tips because the heavy rotor plate remains inside the mill, and all that needs replacement are the relatively light vane tips. This ease of replacement significantly reduces mill maintenance costs.

Furthermore, the vane tips allow for customization of the composition of the vane tips. While the standard mill vane tips are comprised of the same metal, ceramic, or polymers the vane and plate are comprised of; replaceable tips can also be made out of more durable wear substances like carbide that will prolong the overall lifespan of the mill, reducing maintenance costs.

The replaceable vane tips are typically attached to the plate and/or vane through a combination of at least one fastener and several interfacing geometric shapes on both the surface of the vane and the replaceable tip.

These interfacing geometric shapes form structures on the vane and tips that fit adjacent to each other when the replaceable tip is set into place on the vane. These adjacent structures are formed such that the structures assert a force upon each other when the rotor blade spins, and the force helps hold the vane tips in place on the end of the vane.

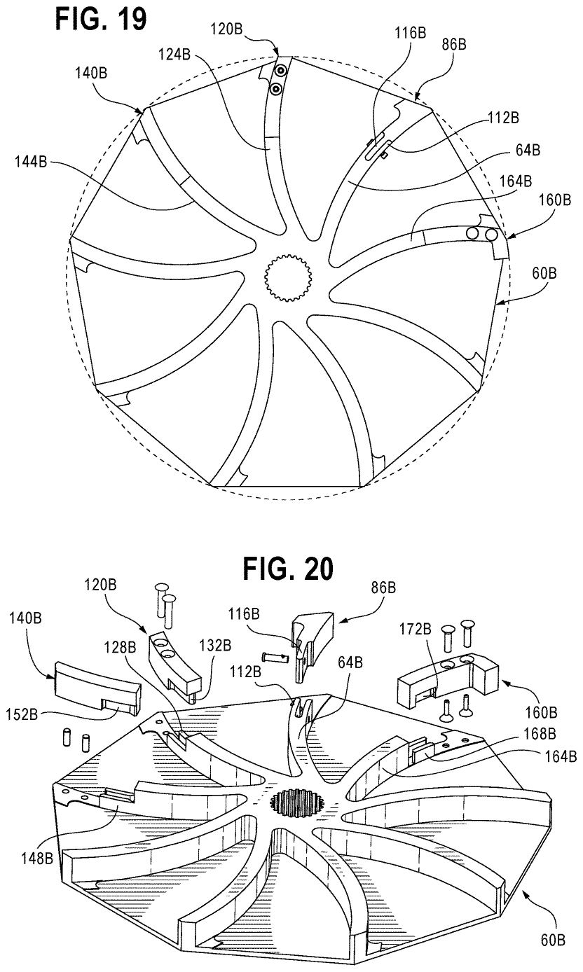

With reference to FIGS. 19 and 20, one such embodiment of this removable or adjustable vane tip innovation is designated by the numeral 86B, where the end of the vane 64B terminates in two walls 112B as high as the vane 64B is tall, forming a U-shape pointed outward towards the perimeter of the rotor plate 60B. Inside the U-shaped walls is a void that matches the shape of a tab 116B that extends radially inwardly from the replaceable tip 86B. When installed, the extending tab 116B of the replaceable tip 86B fits into the U-shaped structure of the vane 64B, and at least one pin, bolt, or other connecting means is inserted through the walls of both the U-shape 112B and the tab 116B.

FIGS. 19-24 further illustrate a second embodiment of this removable or adjustable vane tip innovation, which is designated by the numeral 120B, where the end of the vane 124B terminates in two walls that 128B do not extend as high as the vane 124B is tall. These walls 128B form a U-shape pointing outward towards the rotor plate 60B perimeter. Inside the U-shaped walls 128B is a void that matches the shape of a partial tab 132B that extends from the replaceable tip 120B. When the tip 120B and vane 12 124B are placed together, the partial tip tab 132B extends down into the partial U-shape such that the top of the tip 120B aligns with the top of the vane 124B. At least one fastener (like a bolt or other connecting means) is inserted through the top of the tip 120B down through the rotor plate 60B.

FIGS. 19-24 further illustrate a third embodiment of this removable or adjustable vane tip innovation, which is designated by the numeral 140B, where the end of the vane 144B terminates in two walls 148B that do not extend as high as the vane 144B is tall. These walls 128B form a U-shape pointing outward towards the rotor plate 60B perimeter. Inside the U-shaped walls 148B is a club-shaped or keyed void that matches the shape of the club-shaped distal end of the partial tab 152B that extends from the replaceable tip 140B in a club shape. When the tip 140B and vane 144B are placed together, the partial tip tab 152B extends down into the partial U-shape such that the top of the tip 140B aligns with the top of the vane 144B. At least one fastener (like a bolt, pin, or other connecting means) is inserted through the top of the tip 140B down through the rotor plate 60B.

FIGS. 19-24 further illustrate a fourth embodiment of this removable or adjustable vane tip innovation, which is designated by the numeral 160B, where the end of the vane 164B terminates in two walls 168B that do not extend as high as the vane 164B is tall. These walls 168B are not connected to the rest of the vane 164B but instead, stand unsupported on the surface of the rotor plate 60B. The walls are placed parallel to each other but perpendicular to the rotor plate perimeter to align with the terminated vane. The arrangement of these walls 168B forms a T-shaped void between the walls and the vane's terminating end. This T-shape exactly matches the bottom of the body of the proximal body or tab 172B of the replaceable tip 160B such that the two freestanding walls 168B fit into the body of the tab 172 when the tip 160B and the vane 164B are placed together in alignment with the vane's direction. When the tip and vane are placed together the top of the tip aligns with the top of the vane. Several fasteners (like pins or bolts) are inserted through the top of the tip 160B down through the rotor plate 60B.

In another embodiment of this innovation (not illustrated), the end of the vane terminates in two walls that do not extend as high as the vane is tall. These walls form a U-shape pointing outward towards the rotor plate's perimeter. Inside the U-shaped walls is a void that matches the shape of a partial tab that extends from the replaceable tip. When the tip and vane are placed together, the partial tip tab extends down into the partial U-shape such that the top of the tip aligns with the top of the vane. At least one fastener is then inserted through the tip into either the partial walls or the rotor plate.

These four disclosures are the preferred embodiments of the replaceable tips but are only examples of replaceable tips and are not considered the full range of replaceable or adjustable tips claimed by this invention. The number of walls, tabs, or structures on the vanes and replaceable tips can be varied to give the vanes more or less strength and flexibility depending on the material being milled. Similarly, the number and type of fasteners can be changed based on the desired performance of the mill. More fasteners can be added to increase the durability of the attachment method of the tips, or the bolt fasteners disclosed above can be substituted for other fastening means like rivets, press-pins, clips, or welded joints for a more secure and semipermanent tip installation method.

With reference now to FIGS. 27 and 28, components of yet another embodiment of a mill 40C are illustrated. Like elements between the first illustrated embodiment of the mill 40 and the additional illustrated embodiment of the mill 40C are designated with the same numeral (the first embodiment numbered features having no suffix and the additional embodiment having numbered features with an “C” suffix). The wavelike shape of the lobes 54C in the last illustrated embodiment of the invention are modified to exhibit a different ornamental or aesthetic design as defined by the plates or walls 76C of the housing 44C, where each lobe 54C has a first long side 90C that slopes shallowly or gradually from the base 88C of the mound to the top point 84C of the lobe 54C. At the top point 84C, the lobe 54C then has a second short side 94C that sweeps back to the base 88C of the lobe 54C (at the chamber wall) in a substantially, direct ninety-degree angle.

Various modifications and alterations to this invention will become apparent to those skilled in the art without departing from the scope and spirit of this invention. Illustrative embodiments and examples of the system are provided as examples only and are not intended to limit the scope of the present invention.

1. An apparatus for pulverizing wet or dry material into relatively smaller components, wherein the apparatus comprises:
a housing defining an enclosed chamber, wherein the chamber has at least one inlet through which material may enter the chamber and at least one outlet through which material may exit the chamber, and wherein the interior of the chamber is circumferentially arrayed with at least one lobe that extends inwards from the chamber walls towards the center of the chamber, wherein the at least one lobe has a first side that extends with a shallow slope from a base of the at least one lobe to a top of the at least one lobe, and a second opposite side that extends with a sharp slope down to the base of the at least one lobe, wherein the base of the at least one lobe is at the same distance as the chamber walls from the center of the chamber;
a rotatable shaft crossing from one side of the chamber to the other side;
at least one rotor assembly coupled to the rotor shaft, wherein each rotor assembly includes a plate or series of plates, wherein said plates have a series of vanes affixed which extend across the plates and terminate in a vane tip; and
a motor operatively connected to the rotatable shaft and adapted to spin the rotor assembly.

2. An apparatus for pulverizing wet or dry material into relatively smaller components, wherein the apparatus comprises:
a housing defining an enclosed chamber, wherein the chamber has at least one inlet through which material may enter the chamber and at least one outlet through which material may exit the chamber, and wherein the chamber's interior is circumferentially arrayed with at least one lobe that extends inwards towards the center of the chamber;
a rotatable shaft crossing from one side of the chamber to the other side;
at least one rotor assembly coupled to the rotor shaft, wherein each rotor assembly includes a plate or series of plates, wherein said plates have a series of vanes affixed which extend across the plates, wherein each vane has an adjustable or removable tip at the edge of the plate; and
a motor operatively connected to the rotatable shaft and adapted to spin the rotor assembly.

3. An apparatus for pulverizing wet or dry material into relatively smaller components, wherein the apparatus comprises:
a housing defining an enclosed chamber, wherein the chamber has at least one inlet through which material may enter the chamber and at least one outlet through which material may exit the chamber, and wherein said chamber has a ramp leading to the inlet, wherein the ramp has a first shallow end pointing opposite to the rotor assembly's direction of rotation, and a second relatively higher end pointing in the direction of the rotor assembly's direction of rotation, and wherein the chamber's interior is circumferentially arrayed with at least one lobe that extends inwards towards the center of the chamber;
a rotatable shaft crossing from one side of the chamber to the other side;
at least one rotor assembly coupled to the rotator shaft, wherein each rotator assembly includes a plate or series of plates, wherein said plates have a series of vanes affixed which extend across the plates and terminate in a vane tip;
and a motor operatively connected to the rotatable shaft and adapted to spin the rotator assembly.

4. The apparatus of claim 1, wherein the chamber has a plurality of lobes arranged in a series wherein the base of one lobe is the start of the next lobe's shallow side, such that the entire inner circumference of the chamber to be covered with lobes.

5. The apparatus of claim 1, wherein the chamber has between seven and twelve wavelike lobes.

6. The apparatus of claim 1, wherein the chamber has a plurality of lobes, and at least one of the lobes is set to a different height relative to the rest of the lobes.

7. The apparatus of claim 1, wherein said first side and said second side of said at least one lobe are symmetrical.

8. The apparatus of claim 1, wherein the second opposite side extends down at a ninety-degree angle toward the base of the lobe, wherein the base of the lobe is at the same distance as the chamber walls from the center of the chamber.

9. The apparatus of claim 1, wherein the rotor assembly rotates between 2,500 and 10,000 RPM.

10. The apparatus of claim 1, wherein the top of the at least one lobe extends towards the center of the chamber at a range of height greater or equal to one-thousandth of an inch, but less than an inch, from a circumference of the vane tip, and wherein the base of the lobes, which are set at the same height as the adjacent inner chamber wall, are each at a range of distance within the range of one-quarter of an inch to five inches from the rotating vane tip's circumference or optionally from the rotating plate's circumference.

11. The apparatus of claim 2, wherein the at least one lobe defines a top that extends towards the center of the chamber at a range of height wherein the top of the at least one lobe is greater or equal to one thousandth of an inch, but less than an inch, from a circumference of the vane tips and wherein the at least one lobe defines a base at a range of distance within the range of one-quarter of an inch to five inches from the circumference of the vane tips.

12. The apparatus of claim 2, wherein the vanes in the rotor assembly terminate near the outside of the plate, and said termination comprises of at least two walls placed perpendicular to a circumference of the rotor plate, wherein said walls have with at least one hollow space between them, and wherein said termination further comprises an adjustable or replaceable tip which comprises:
at least one tab or wall sized to fit into the beforementioned space or spaces between the perpendicular walls of the vane's terminating end; and
and at least one fastener which extends through the vane-tip and at least one of the list comprising: the perpendicular vane-walls and the rotor plate.

13. The apparatus of claim 2, wherein the vanes in the rotor assembly terminate near the outside of the plate, and said termination comprises a wall or series of adjacent walls, and wherein said termination further comprises an adjustable or replaceable tip which comprises:
at least one tab or wall sized to fit around or between the vane wall or vane walls; and
and at least one fastener which extends through the vane-tip and at least one of the list comprising: the perpendicular vane-walls and the rotor plate.

14. The apparatus of claim 2, wherein the vanes in the rotor assembly terminate near the outside of the plate, and said termination comprises a partial-wall or series of adjacent partial-walls that are shorter than the height of the vane and wherein said termination further comprises an adjustable or replaceable tip which comprises:
at least one tab or wall sized to fit around, between, and on top of the vane's terminating partial walls to cause the tip's total height and sides to match and sit flush with the outside dimensions of the vanes;
and at least one fastener which extends through the vane-tip and at least one of the list comprising: the partial vane walls and the rotor plate.

15. The apparatus of claim 2, wherein the rotor assembly rotates between 2,500 and 10,000 RPM.

16. The apparatus of claim 2, wherein the replaceable or adjustable tips are comprised of a substance selected from a wear element or a member of the group consisting of carbide, steel, iron, rubber, aluminum, titanium, and polymer.

17. The apparatus of claim 3, wherein the at least one lobe defines a top that extends towards the center of the chamber at a range of height wherein the top of the at least one lobe is greater or equal to one-thousandth of an inch, but less than an inch, from a circumference of the vane tip and wherein the at least one lobe defines a base at a range of distance within the range of one-quarter of an inch to five inches from the circumference of the vane tip.

18. The apparatus of claim 3, wherein the rotor assembly rotates between 2,500 and 10,000 RPM.

19. The apparatus of claim 3, wherein the ramp's relatively higher end terminates in a curved partial circle shape that matches a circumference of the chamber's inlet, and wherein the ramp is placed adjacent to the inlet.

20. The apparatus of claim 3, wherein the ramp's relatively higher end terminates in a ring shape portion with walls as high as the ramp's higher end, and wherein the ring shape portion of the ramp fits over the chamber's inlet.
